(19) United States
(12) Patent Application Publication
(10) Pub. No.: US 2020/0408120 A1
(43) Pub. Date: Dec. 31, 2020

(54) CONTROL DEVICE FOR INTERNAL COMBUSTION ENGINE

(71) Applicant: TOYOTA JIDOSHA KABUSHIKI KAISHA, Aichi-ken (JP)

(72) Inventor: Toru UENISHI, Susono-shi (JP)

(21) Appl. No.: 16/882,751

(22) Filed: May 26, 2020

(30) Foreign Application Priority Data
Jun. 25, 2019 (JP) 2019-117269

(51) Int. Cl. F01N 3/023; F01N 3/033; B01D 46/24; B01D 51/02; B01D 46/42

(52) U.S. Cl. CPC F01N 3/023; F01N 3/033; B01D 2279/30; B01D 51/02; B01D 46/4245; B01D 46/2418

(57) ABSTRACT

An internal combustion engine provided with an engine body, a filter provided in an exhaust passage of the engine body and trapping PM in the exhaust, and an aggregating device charging PM in the exhaust flowing into the filter to make it aggregate. The control device for controlling the internal combustion engine is provided with a PM charging control part controlling the amount of charging of the PM in the exhaust flowing into the filter. The PM charging control part controls the aggregating device so that the amount of charging of the PM becomes smaller when the amount of PM buildup of the filter is large compared with when it is small.

### FIELD

The present disclosure relates to a control device for an internal combustion engine.

### BACKGROUND

Japanese Unexamined Patent Publication No. 2006-188979 discloses as a conventional internal combustion engine one which charges particulate matter in exhaust (below, referred to as “PM”) to make it aggregate and increase the particle size and which traps the PM enlarged in particle size by a PM trapping material inside a muffler.

### SUMMARY

A PM trapping rate of a PM filter for trapping PM changes in accordance with an amount of PM built up on the PM filter (below, referred to as the “amount of PM buildup”). Specifically, the PM trapping rate tends to become higher if a certain extent of PM builds up on the surface of the PM filter and a layer of PM is formed on the filter surface (PM cake layer) since it becomes possible to use the PM cake layer to trap PM with a small particle size which would have passed through the filter before the formation of the PM cake layer. Further, the PM trapping rate tends to become higher if a certain extent of PM builds up inside of the partition walls forming the PM filter since even if PM with a small particle size enters inside the partition walls, it is possible to trap the PM with a small particle size by the PM which has already built up inside the partition walls.

However, in the above-mentioned conventional internal combustion engine, the PM was charged and made to aggregate to increase the particle size without considering such a PM trapping rate, so the PM was unnecessarily charged even after the PM cake layer was formed or a certain extent of PM built up inside the partition walls and a state was reached making it possible to trap PM with a small particle size, that is, even after a state was reached making it possible to trap PM without charging the PM to make it aggregate to increase the particle size. Therefore, the electric power for charging the PM was liable to end up being wastefully consumed.

The present disclosure was made focusing on such a problem and has as its object to suppress the amount of electric power for charging PM while raising a PM trapping rate of a PM filter earlier.

To solve the above problem, an internal combustion engine according to one aspect of the present disclosure is provided with an engine body, a filter provided in an exhaust passage of the engine body and trapping PM in exhaust, and an aggregating device charging the PM in the exhaust flowing into the filter to make it aggregate. The control device for the internal combustion engine is provided with a PM charging control part configured to control the amount of charging of the PM in the exhaust flowing into the filter. The PM charging control part is configured so as to control the aggregating device so that the amount of charging of PM becomes smaller when the amount of PM buildup of the filter is large compared with when it is small.

According to this aspect of the present disclosure, it is possible to keep down the amount of electric power for charging the PM while raising the PM trapping rate of the PM filter earlier.

### BRIEF DESCRIPTION OF DRAWINGS

FIG. 1 is a schematic view of the configuration of an internal combustion engine according to a first embodiment of the present disclosure and an electronic control unit for controlling the internal combustion engine.

FIG. 2A is a front view of a PM filter according to the first embodiment of the present disclosure.

FIG. 2B is a side cross-sectional view of the PM filter according to the first embodiment of the present disclosure.

FIG. 3 is a flow chart explaining PM charging control according to the first embodiment of the present disclosure.

FIG. 4 is a time chart explaining operation of PM charging control according to the first embodiment of the present disclosure.

FIG. 5 is a view showing a relationship between a PM aggregating force and state of filter inflow and exhaust (PM particle size, exhaust temperature, and exhaust flow rate).

FIG. 6 is a view showing a relationship between a PM trapping rate and state of filter inflow and exhaust (PM particle size, exhaust temperature, and exhaust flow rate).

FIG. 7 is a flow chart explaining PM charging control according to a second embodiment of the present disclosure.

FIG. 8 is a flow chart explaining processing for calculating a target voltage.

FIG. 9 is a flow chart explaining PM charging control according to a modification of the first embodiment of the present disclosure.

### DESCRIPTION OF EMBODIMENTS

Below, referring to the drawings, embodiments of the present disclosure will be explained in detail. Note that, in the following explanation, similar component elements are assigned the same reference notations.

### First Embodiment

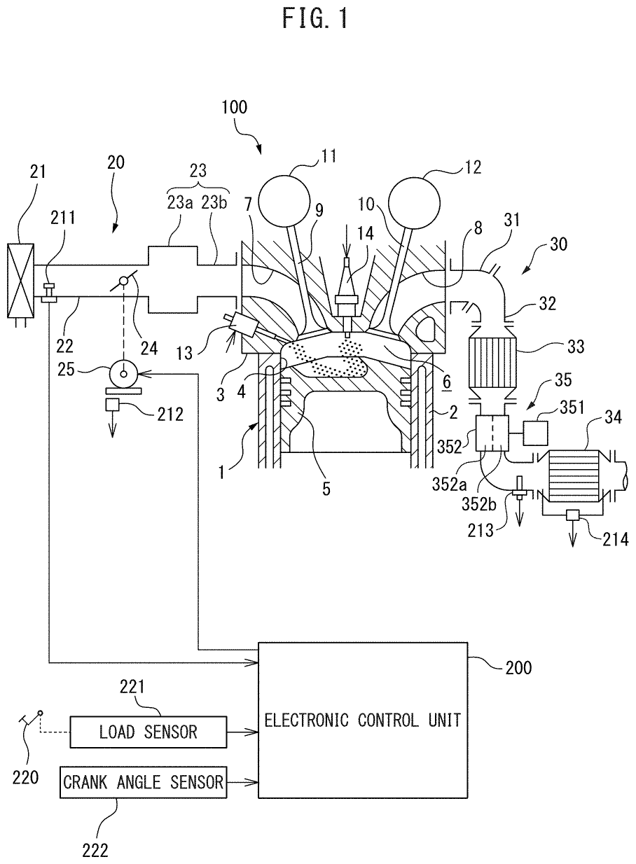

FIG. 1 is a schematic view of the configuration of an internal combustion engine 100 according to a first embodiment of the present disclosure and an electronic control unit 200 for controlling the internal combustion engine 100.

The internal combustion engine 100 according to the present embodiment is a spark ignition type gasoline engine provided with an engine body 1, intake system 20, and exhaust system 30. Note that the type of the internal combustion engine 100 is not particularly limited and may also be a homogenous charged compression ignition type gasoline engine or may be a diesel engine.

The engine body 1 is provided with a cylinder block 2 and cylinder head 3 fixed on the top surface of the cylinder block 2.

The cylinder block 2 is formed with a plurality of cylinders 4. Inside of the cylinders 4, pistons 5 moving back and forth inside of the cylinders by receiving combustion pressure are held. The pistons 5 are connected through connecting rods (not shown) to a crankshaft (not shown). Using the crankshaft, the reciprocating motions of the pistons 5 are converted to rotary motion. Spaces defined by the inside wall surface of the cylinder head 3, inside wall surfaces of the cylinders 4, and crowns of the pistons form the combustion chambers 6.

At the cylinder head 3, intake ports 7 opening to one side surface of the cylinder head 3 and opening to the combustion chambers 6 and exhaust ports 8 opening to another side surface of the cylinder head 3 and opening to the combustion chambers 6 are formed.

Further, the cylinder head 3 has attached to it intake valves 9 for opening and closing the openings between the combustion chambers 6 and intake ports 7, exhaust valves 10 for opening and closing the openings between the combustion chambers 6 and exhaust ports 8, intake cam shafts 11 for driving operations of the intake valves 9, and exhaust cam shafts 12 for driving operations of the exhaust valves 10.

Furthermore, the cylinder head 3 has attached to it fuel injectors 13 for injecting fuel to the insides of the combustion chambers 6 and spark plugs 14 for igniting the air-fuel mixtures of fuel and air injected from the fuel injectors 13 to inside of the combustion chambers 6. Note that the fuel injectors 13 may also be attached to the cylinder head 3 so as to enable fuel to be injected to the insides of the intake ports 7.

The intake system 20 is a system for guiding air through the intake ports 7 to the insides of the cylinders 4 and is provided with an air cleaner 21, intake pipe 22, intake manifold 23, air flow meter 211, electronic control type throttle valve 24, throttle actuator 25, and throttle sensor 212.

The air cleaner 21 removes sand and other foreign matter contained in the air.

The intake pipe 22 is connected at one end to the air cleaner 21 and is connected at the other end to a surge tank 23a of the intake manifold 23. Due to the intake pipe 22, air flowing through the air cleaner 21 to the inside of the intake pipe 22 (intake air) is guided to the surge tank 23a of the intake manifold 23.

The intake manifold 23 is provided with the surge tank 23a and a plurality of intake runners 23b branched from the surge tank 23a and connected to the openings of the intake ports 7 formed at the side surface of the cylinder head. The air guided to the surge tank 23a is equally distributed through the intake runners 23b to the insides of the cylinders 4. In this way, the intake pipe 22, intake manifold 23, and intake ports 7 form an intake passage for guiding air to the insides of the cylinders 4.

The air flow meter 211 is provided inside the intake pipe 22. The air flow meter 211 detects the amount of flow of air flowing through the inside of the intake pipe 22 (below, referred to as the “intake amount”). In the present embodiment, the amount of flow FE of exhaust flowing into the PM filter 34, explained later, is estimated based on the intake amount detected by the air flow meter 211 and the amount of fuel injected from the fuel injectors 13.

The throttle valve 24 is provided inside of the intake pipe 22 at the downstream side from the air flow meter 211. The throttle valve 24 is driven by the throttle actuator 25 and makes the passage sectional area of the intake pipe 22 change continuously or in stages. The intake amounts taken into the cylinders 4 are adjusted by the throttle actuator 25 adjusting the opening degree TH of the throttle valve 24 (below, referred to as the “throttle opening degree”). The throttle opening degree is detected by the throttle sensor 212.

The exhaust system 30 is a system for scrubbing the combustion gas generated inside the combustion chambers 6b (below, referred to as the “exhaust”) for discharge to the outside air and is comprised of an exhaust manifold 31, exhaust pipe 32, catalyst device 33, wall flow type PM filter 34, aggregating device 35, exhaust temperature sensor 213, and differential pressure sensor 214.

The exhaust manifold 31 is provided with a plurality of exhaust runners connected to openings of the exhaust ports 8 formed at the side surface of the cylinder head and a header pipe which collects the exhaust runners into a single pipe.

The exhaust pipe 32 is connected at one end to the header pipe of the exhaust manifold 31 and opens at the other end to the outside air. Exhaust discharged from the cylinders 4 through the exhaust ports 8 to the exhaust manifold 31 flows through the exhaust pipe 32 and is discharged to the outside air.

The catalyst device 33 is comprised of a support on which an exhaust purification catalyst is carried and is provided in the exhaust pipe 32. The exhaust purification catalyst is for example an oxidation catalyst (two-way catalyst) or three-way catalyst, but is not limited to these. Suitable catalysts may be used in accordance with the type or application of the internal combustion engine 100. In the present embodiment, as the exhaust purification catalyst, a three-way catalyst is used. If using a three-way catalyst as the exhaust purification catalyst, the harmful substances in the exhaust, that is, hydrocarbons (HC), carbon monoxide (CO), and nitrogen oxides (NOx), are removed by the catalyst device 33.

The PM filter 34 is provided in the exhaust pipe 32 at the downstream side of the catalyst device 33 in the direction of exhaust flow and traps the PM contained in the exhaust. The PM filter 34 is sometimes called a “GPF (gasoline particulate filter)” when the internal combustion engine 100 is a gasoline engine and is sometimes called a “DPF (diesel particulate filter)” when the internal combustion engine 100 is a diesel engine.

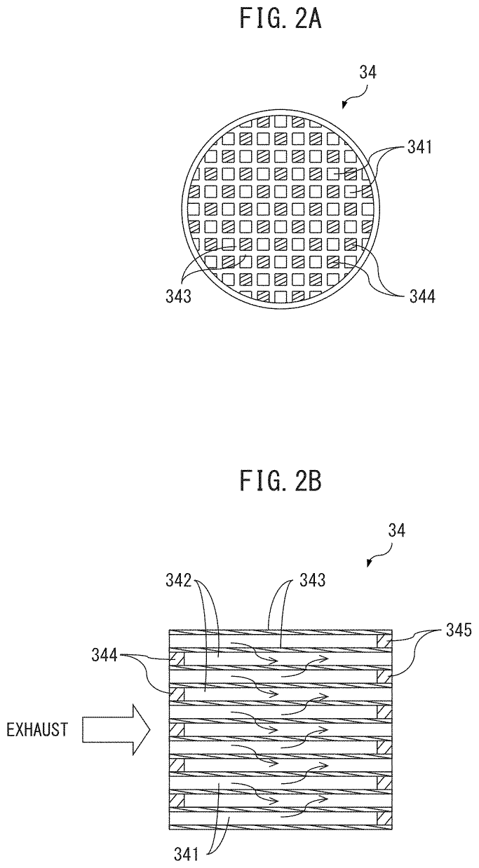

FIG. 2A and FIG. 2B are views explaining the structure of the PM filter 34 according to the present embodiment. FIG. 2A is a front view of the PM filter 34, while FIG. 2B is a side cross-sectional view of the PM filter 34.

As shown in FIG. 2A and FIG. 2B, the PM filter 34 has a honeycomb structure and is provided with a plurality of exhaust flow passages 341, 342 extending in parallel with each other and partition walls 343 partitioning the exhaust flow passages 341, 342.

The exhaust flow passages 341, 342 are comprised of exhaust inflow passages 341 which are opened at their upstream ends and closed at their downstream ends by downstream plugs 345 and of exhaust outflow passages 342 which are closed at their upstream ends by upstream plugs 344 and opened at their downstream ends. Note that, in FIG. 2A, the hatched parts show the upstream plugs 344. Therefore, the exhaust inflow passages 341 and the exhaust outflow passage 342 are alternately arranged through thin partition walls 343. In other words, the exhaust inflow passages 341 and the exhaust outflow passage 342 are arranged so that each exhaust inflow passage 341 is surrounded by four exhaust outflow passages 342 and so that each exhaust outflow passage 342 is surrounded by four exhaust inflow passages 341.

The partition walls 343 are formed from a porous material, for example, cordierite, silicon carbide, silicon nitride, zirconia, titania, alumina, silica, mullite, lithium aluminum silicate, and zirconium phosphate or other such ceramic. Therefore, as shown by the arrows in FIG. 2B, exhaust first flows into the exhaust inflow passages 341, then passes through the surrounding partition walls 343 to flow out into the adjoining exhaust outflow passages 342. In this way, the partition walls 343 constitute the inside circumferential surfaces of the exhaust inflow passages 341.

Returning to FIG. 1, the aggregating device 35 is provided with a voltage applying part 351 and a charging part 352 having a first discharging part 352a and second discharging part 352b.

The voltage applying part 351 is electrically connected to the first discharging part 352a and second discharging part 352b and is configured to be able to apply a positive voltage to the first discharging part 352a and a negative voltage to the second discharging part 352b.

The charging part 352 is provided in the exhaust pipe 32 between the catalyst device 33 and the PM filter 34. The first discharging part 352a of the charging part 352 is configured to be able to generate a positive corona discharge and positively charge the PM in the exhaust passing the first discharging part 352a when a predetermined positive voltage is applied through the voltage applying part 351 between discharge electrodes arranged inside it. The second discharging part 352b of the charging part 352 is configured to be able to generate a negative corona discharge and negatively charge the PM in the exhaust passing the second discharging part 352b when a predetermined negative voltage is applied through the voltage applying part 351 between discharge electrodes arranged inside it.

By driving the thus configured aggregating device 35, it is possible to cause aggregation of positively charged PM and negatively charged PM contained in the exhaust passing the charging part 352 by electrostatic action between them (static electricity). As a result, it is possible to decrease the number of particles of PM in the exhaust flowing into the PM filter 34 and to increase the particle size of the PM.

The exhaust temperature sensor 213 is provided in the exhaust pipe 32 near the inlet side of the PM filter 34 and detects the temperature TE of the exhaust flowing into the PM filter 34. In the present embodiment, the temperature TF of the PM filter 34 (below, referred to as the “filter temperature”) is estimated based on the exhaust temperature TE detected by this exhaust temperature sensor 213. However, the filter temperature TF is not limited to being estimated by such a method. For example, it may be estimated according to the engine operating state or be otherwise estimated by a method suitably selected from among various known techniques. In estimating the filter temperature TF, the exhaust temperature sensor 213 is not necessarily required.

The differential pressure sensor 214 is provided at the PM filter 34 and detects the pressure difference PD before and after the PM filter 34 (below, referred to as the “filter differential pressure”).

The electronic control unit 200 is a microcomputer provided with components connected with each other by a bidirectional bus such as a central processing unit (CPU), read only memory (ROM), random access memory (RAM), input port, and output port.

The electronic control unit 200 receives as input the output signals from various types of sensors such as the above-mentioned air flow meter 211 and throttle sensor 212, exhaust temperature sensor 213, and differential pressure sensor 214 and also a load sensor 221 generating an output voltage proportional to the amount of depression of an accelerator pedal 220 corresponding to the load of the engine body 1 (engine load) (below, referred to as the “amount of accelerator depression”) and crank angle sensor 222 generating an output pulse every time a crankshaft (not shown) of the engine body 1 rotates by for example 15° as a signal for calculating the engine rotational speed etc.

Further, the electronic control unit 200 controls the fuel injectors 13 or throttle valve 24 etc. to control the internal combustion engine 100 based on the output signals of the various types of sensors received as input etc. Below, one control routine of the internal combustion engine 100 performed by the electronic control unit 200, PM charging control, will be explained.

As explained above, the PM trapping rate of the PM filter 34 (ratio of PM trapped by the PM filter 34 in the PM flowing into the PM filter 34) changes according to the amount of PM buildup of the PM filter 34 and basically tends to become higher when the amount of PM buildup is large compared to when it is small.

In particular, the PM trapping rate of the PM filter 34 tends to become higher when the inside circumferential surfaces of the exhaust inflow passages 341 are covered by the PM trapped at the PM filter 34 and a layer of PM is formed on the inside circumferential surfaces of the exhaust inflow passages 341 (below, referred to as the “PM cake layer”). This is because PM with a small particle size which would have passed through the pores inside the partition walls 343 (that is, slipped through the filter 34) and flowed out from the exhaust inflow passages 341 to the exhaust outflow passages 342 before the PM cake layer was formed is trapped at the PM cake layer and builds up on the PM cake layer after the PM cake layer is formed.

Further, the PM trapping rate of the PM filter 34 tends to become higher if a certain extent of PM builds up in pores inside the partition walls 343 separate from such a PM cake layer. This is because if a certain extent of PM already builds up in the pores inside the partition walls 343, even if PM with a small particle size enters the pores inside the partition walls 343, it becomes possible to trap PM with a small particle size by PM already built up in the pores inside the partition walls 343.

Therefore, if possible to form a PM cake layer earlier, it would be possible to raise the PM trapping rate of the PM filter 34 earlier, so it would be possible to improve the exhaust emission. Further, if possible to make a certain extent of PM build up earlier at the pores inside the partition walls 343, it would be possible to similarly raise the PM trapping rate of the PM filter 34 earlier, so it would be possible to improve the exhaust emission.

Therefore, in the present embodiment, when the state of the PM filter 34 is a low trapping state where the amount of PM buildup of the PM filter 34 is a certain amount or less and where the PM trapping rate is low when before a PM cake layer is formed or before a certain extent of PM has built up in the pores inside the partition walls 343, the aggregating device 35 is driven to enlarge the particle size of the PM in the exhaust. Due to this, it is possible to make the PM which had been enlarged and became difficult to pass through the pores at the inside of the partition walls 343 build up on the inner circumferential surfaces of the exhaust inflow passages 341 in a short time, so a PM cake layer can be formed earlier. Further, it is possible to make it easier to make the PM which had been enlarged and became difficult to pass through the pores build up in the pores even if the PM entered the pores inside the partition walls 343. As a result, it is possible to raise the PM trapping rate of the PM filter 34 earlier, so it is possible to improve the exhaust emission.

Further, after the PM cake layer is formed and a certain extent of PM builds up in the pores inside the partition walls 343, it becomes possible to trap PM with a small particle size at the PM cake layer or the inside of the partition walls 343, so the aggregating device 35 is stopped. In this way, after the state of the PM filter 34 shifts from a low trapping state to a high trapping state with a high PM trapping rate after a PM cake layer is formed and a certain extent of PM has built up in the pores inside the partition walls 343, it is possible to stop the aggregating device 35 to thereby make the state of the PM filter 34 shift from the low trapping state to the high trapping state earlier while keeping down the amount of electric power consumed by the aggregating device 35.

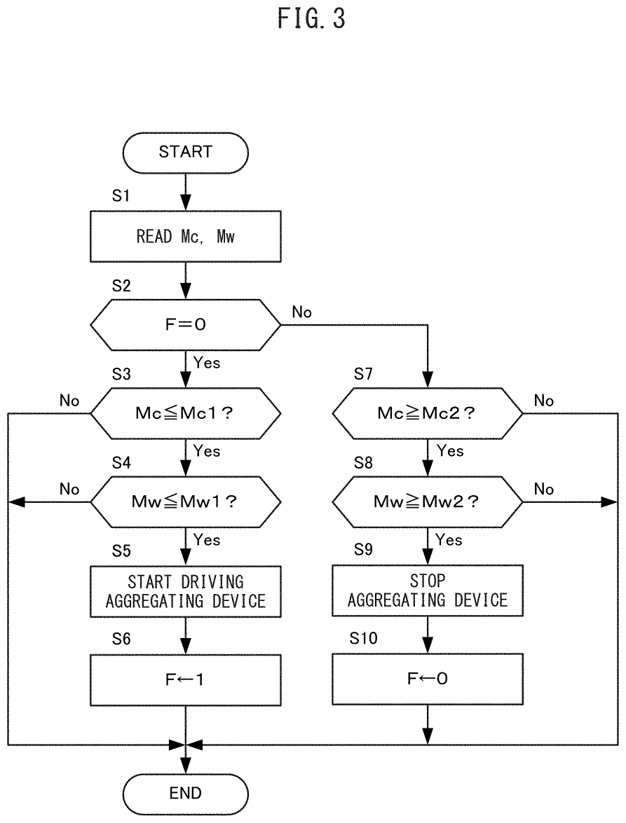

FIG. 3 is a flow chart explaining the PM charging control according to the present embodiment. The electronic control unit 200 repeatedly performs the present routine during engine operation at predetermined processing cycles. Note that, below, the amount of PM building up on the inside circumferential surfaces of the exhaust inflow passages 341, that is, the amount of the PM forming the PM cake layer, will be referred to as the “amount of buildup of the cake layer Mc” while the amount of PM building up in the pores inside the partition walls 343 will be referred to as the “amount of buildup of the wall layer Mw”.

At step S1, the electronic control unit 200 reads in the amount of buildup of the cake layer Mc and the amount of buildup of the wall layer Mw calculated at various times during engine operation separate from the present routine. The amount of buildup of the cake layer Mc and the amount of buildup of the wall layer Mw can be calculated using for example the following formula (1) and formula (2) assuming that when the PM built up in the pores inside the partition walls 343 is burned, the PM of the PM cake layer will enter the pores inside the partition walls 343:

Mc=Mc+dMc−Rc−ξ×Rw (1)

Mw=Mw−Rw+ξ×Rw (2)

In formula (1), dMc is the amount of PM per unit time built up at the PM cake layer. dMc can, for example, be calculated based on the engine operating state (engine load and engine speed) referring to a map etc. prepared in advance by experiments etc. Rc is the amount of PM per unit time burned at the PM cake layer. Rw is the amount of PM per unit time burned inside of the partition walls 343. Rc and Rw can respectively, for example, be calculated based on the filter temperature TF and intake amount etc. referring to a map etc. prepared in advance by experiments etc. ξ is a coefficient expressing the ratio of PM moving from the PM cake layer to the pores inside of the partition walls 343 and is a constant determined in advance by experiments etc.

At step S2, the electronic control unit 200 judges if an aggregating device drive flag F has been set to 0. The aggregating device drive flag F is a flag set to 1 while driving the aggregating device 35. The initial value is set to 0. The electronic control unit 200 proceeds to the processing of step S3 if the aggregating device drive flag F has been set to 0. On the other hand, the electronic control unit 200 proceeds to the processing of step S7 if the aggregating device drive flag F is set to 1.

At step S3 and step S4, the electronic control unit 200 judges if the amount of PM buildup of the PM filter 34 is an amount of buildup for start judgment for starting to drive the aggregating device 35 or less and proceeds to the processing of step S4 to start driving the aggregating device 35 if the amount of PM buildup is the amount of buildup for start judgment or less. On the other hand, the electronic control unit 200 ends the current processing if the amount of PM buildup becomes greater than the amount of buildup for start judgment. The amount of buildup for start judgment can for example be set to a value corresponding to the amount of PM buildup at the time of completion of regeneration of the PM filter 34 or right before or right after completion.

In the present embodiment, at step S3, the electronic control unit 200 judges if the amount of buildup of the cake layer Mc is a predetermined threshold value Mc1 or less. The threshold value Mc1 is a constant determined in advance by experiments etc. In the present embodiment, it is made a value corresponding to the amount of buildup of the cake layer Mc at the time of completion of regeneration of the PM filter 34 or right before or right after the completion. Note that, the “regeneration of the PM filter 34” is treatment performed before the PM filter 34 becomes clogged where the exhaust temperature is made to rise to a predetermined regeneration target temperature (for example 650° C.) to forcibly burn off the trapped PM and regenerate the PM filter 34. The regeneration is, for example, performed when the filter differential pressure PD becomes a preset predetermined allowable upper limit value or more. The electronic control unit 200 proceeds to the processing of step S4 if the amount of buildup of the cake layer Mc is the threshold value Mc1 or less. On the other hand, the electronic control unit 200 ends the current processing if the amount of buildup of the cake layer Mc is larger than the threshold value Mc1.

Further, at the step S4, the electronic control unit 200 judges if the amount of buildup of the wall layer Mw is a predetermined threshold value Mw1 or less. The threshold value Mw1 is a constant determined in advance by experiments etc. In the present embodiment, it is made a value corresponding to the amount of buildup of the wall layer Mw at the time of completion of processing of the PM filter 34 or right before or right after completion. The electronic control unit 200 proceeds to the processing of step S5 if the amount of buildup of the wall layer Mw is the threshold value Mw1 or less. On the other hand, the electronic control unit 200 ends the current processing if the amount of buildup of the wall layer Mw is larger than the threshold value Mw1.

At step S5, the electronic control unit 200 starts driving the aggregating device 35.

At step S6, the electronic control unit 200 sets the aggregating device drive flag F to 1.

At step S7 and step S8, the electronic control unit 200 judges if the state of the PM filter 34 has shifted from the low trapping state to the high trapping state during driving of the aggregating device 35, that is, if the amount of PM buildup of the PM filter 34 becomes the amount of buildup for stop judgment for stopping driving of the aggregating device 35 or more. If the amount of PM buildup becomes the amount of buildup for stop judgment or more, the routine proceeds to the processing of step S9 for stopping the aggregating device 35. On the other hand, the electronic control unit 200 ends the current processing if the amount of PM buildup is less than the amount of buildup for stop judgment.

In the present embodiment, at step S7, the electronic control unit 200 judges if the amount of buildup of the cake layer Mc is a predetermined threshold value Mc2 (>Mc1) or more. The threshold value Mc2 is a constant determined in advance by experiments etc. It is a threshold value for judging if a PM cake layer of an extent able to trap PM with a small particle size has been formed at the inner circumferential surfaces of the exhaust inflow passages 341.

The electronic control unit 200 judges that a PM cake layer of an extent able to trap PM with a small particle size has not been sufficiently formed and ends the current processing if the amount of buildup of the cake layer Mc is less than the threshold value Mc2. On the other hand, the electronic control unit 200 judges that a PM cake layer of an extent able to trap PM with a small particle size has been formed and proceeds to the processing of step S8 if amount of buildup of the cake layer Mc is the threshold value Mc2 or more.

Further, at step S8, the electronic control unit 200 judges if the amount of buildup of the wall layer Mw is a predetermined threshold value Mw2 (>Mw1) or more. The threshold value Mw2 is a constant determined in advance by experiments etc. It is a threshold value for judging if the PM already built up in the pores inside the partition walls 343 can be used to trap PM with a small particle size even if PM with a small particle size has entered the pores inside the partition walls 343, that is, if PM has built up in the pores inside the partition walls 343 to an extent able to trap PM with a small particle size.

The electronic control unit 200 judges that PM has not built up in the pores inside the partition walls 343 to an extent able to trap PM with a small particle size and ends the current processing if the amount of buildup of the wall layer Mw is less than the threshold value Mw2. On the other hand, the electronic control unit 200 judges that PM has built up in the pores inside the partition walls 343 to an extent able to trap PM with a small particle size and proceeds to the processing of step S9 if the amount of buildup of the wall layer Mw is the threshold value Mw2 or more.

At step S9, the electronic control unit 200 makes the aggregating device 35 stop.

At step S10, the electronic control unit 200 returns the aggregating device drive flag F to 0.

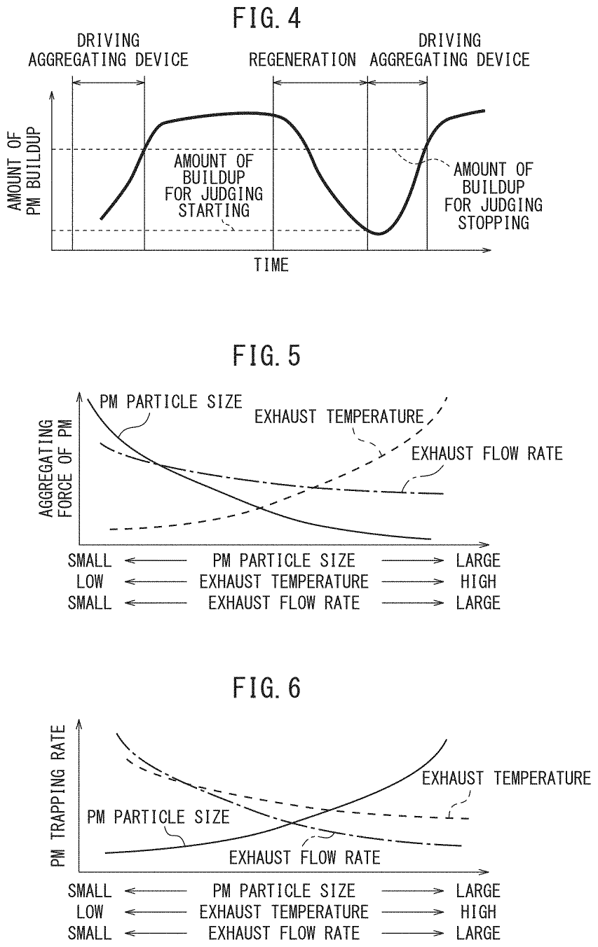

Due to this, as shown in FIG. 4, it is possible to start driving the aggregating device 35 when the state of the PM filter 34 at the time of completion of regeneration or right before or right after completion becomes the lowest trapping state and thereby enlarge the particle size of the PM to form the PM cake layer earlier. Further, it becomes harder for the PM to pass through the pores along with enlargement of the PM, so it is possible to make it easier for the PM to build up in the pores. As a result, it is possible to raise the PM trapping rate of the PM filter 34 earlier to improve the exhaust emission.

Note that, in the flow chart shown in FIG. 3, the aggregating device 35 was made to stop when the amount of buildup of the cake layer Mc became the threshold value Mc2 or more and the amount of buildup of the wall layer Mw became the threshold value Mw2 or more, but the disclosure is not limited to this. For example, it is also possible to stop the aggregating device 35 regardless of the amount of buildup of the wall layer Mw when the amount of buildup of the cake layer Mc becomes the threshold value Mc2 or more. Further, for example, it is also possible to stop the aggregating device 35 regardless of the amount of buildup of the cake layer Mc when the amount of buildup of wall layer Mw becomes the threshold value Mw2 or more. Furthermore, for example, the aggregating device 35 may be stopped when the sum of the amount of buildup of the cake layer Mc and the amount of buildup of the wall layer Mw becomes a predetermined value or more.

Further, in the present embodiment, when driving the aggregating device 35 to charge the PM in the exhaust, the magnitudes of the positive voltage and negative voltage applied between the discharge electrodes arranged at the first discharging part 352a and second discharging part 352b are respectively made constant. That is, in the present embodiment, the aggregating device 35 is controlled so that the amounts of charging of the PM in the exhaust passing the charging part 352 become respectively constant amounts of charging. However, the disclosure is not limited to this. For example, the aggregating device 35 may also be controlled so that as the amount of PM buildup of the PM filter 34 (for example, the sum of the amount of buildup of the cake layer Mc and the amount of buildup of the wall layer Mw) increases, the voltages (absolute values) applied to the discharge electrodes are gradually reduced to reduce the amount of charging of the PM.

The internal combustion engine 100 according to the present embodiment explained above is provided with an engine body 1, a PM filter 34 (filter) provided in the exhaust passage of the engine body 1 and trapping PM in the exhaust, and an aggregating device 35 charging the PM in the exhaust flowing into the PM filter 34 to make it aggregate. The electronic control unit 200 (control device) controlling this internal combustion engine 100 is provided with a PM charging control part controlling the amount of charging of the PM in the exhaust flowing into the PM filter 34.

Further, the PM charging control part is configured so as to control the aggregating device 35 so that the amount of charging of the PM becomes smaller when the amount of PM buildup of the PM filter 34 is large compared to when it is small.

Due to this, according to the present embodiment, when the PM trapping rate of the PM filter 34 is low and the amount of PM buildup is small, it is possible to charge the PM to make it aggregate and enlarge the particle size, so it is possible to keep the PM from ending up slipping through the PM filter 34 while forming a PM cake layer on the surface of the PM filter 34 earlier and raising the PM trapping rate of the PM filter 34. Further, by decreasing the amount of charging of the PM after the amount of PM buildup of the PM filter 34 increases and the PM trapping rate becomes higher (in the present embodiment, making the amount of charging zero), it is possible to keep down the amount of electric power required for charging the PM. Therefore, according to the present embodiment, it is possible to keep down the amount of electric power for charging the PM while raising the PM trapping rate of the PM filter 34 earlier.

Further, in the present embodiment, the PM charging control part is configured to start driving the aggregating device 35 to charge the PM so that the amount of charging of the PM becomes a predetermined amount of charging if the amount of PM buildup of the PM filter 34 is a predetermined amount of buildup for start judgment (first amount of buildup) or less and to stop the aggregating device 35 to stop charging the PM when the amount of PM buildup of the PM filter 34 during driving the aggregating device 35 becomes a predetermined amount of buildup for stop judgment (second amount of buildup) or more larger than the amount of buildup for start judgment.

The amount of buildup for start judgment, for example, can be made a value corresponding to the amount of PM buildup at the time of completion of regeneration of the PM filter 34 or right before or right after completion. The amount of buildup for stop judgment can for example be made the amount of PM buildup enabling judgment of formation of a PM cake layer (layer of PM) on the surface of the PM filter 34.

Further, the amount of buildup for stop judgment can, for example, be made the amount of PM buildup enabling judgment that the PM can be trapped in the pores when PM enters the pores inside the partition walls 343 forming the PM filter 34. Furthermore, the amount of buildup for stop judgment can also, for example, be made the amount of buildup of PM enabling judgment of formation of a layer of PM at the surface of the PM filter 34 and enabling judgment of the ability of PM to be trapped inside the pores when PM has entered into the pores inside of the partition walls 343 forming the PM filter 34.

Due to this, it is possible to start driving the aggregating device 35 from when the state of the PM filter 34 at the time of completion of regeneration of the PM filter 34 or right before or right after completion becomes the lowest trapping state and to thereby enlarge the particle size of the PM to form the PM cake layer earlier and possible to make it easier for the PM to build up in the pores since it becomes harder for the PM to pass through the pores along with enlargement of the PM even if the PM enters inside the partition walls 343. Further, during driving of the aggregating device 35, after the amount of PM buildup of the PM filter 34 becomes the amount of buildup for stop judgment or more and the state of the PM filter 34 changes to the high trapping state, the aggregating device 35 is stopped, so the time period of driving the aggregating device 35 can be optimized and the amount of consumption of electric power can be kept down.

### Second Embodiment

Next, a second embodiment of the present disclosure will be explained. The present embodiment differs from the first embodiment on the point of changing the amount of charging of the PM in accordance with the PM trapping rate and PM aggregating force. Below, the point of difference will be explained.

In the above-mentioned first embodiment, when driving the aggregating device 35 to charge the PM in the exhaust, the positive voltage and the negative voltage applied between the discharge electrodes arranged at the first discharging part 352a and second discharging part 352b were respectively made constant. Therefore, in the above-mentioned first embodiment, the amount of charging Q1 of the positively charged PM and the amount of charging Q2 of the negatively charged PM were also respectively constant.

The PM aggregating force (ease of aggregation of PM) becomes larger the larger the amounts of charging Q1, Q2 since the static electricity becomes larger. That is, the larger the charging forces Q1, Q2, the easier it is for the PM to aggregate and the larger in size the PM can be made, so it is possible to form the PM cake layer earlier. However, to make the amounts of charging Q1, Q2 larger, it is necessary to raise the voltages applied to the discharge electrodes (positive voltage and negative voltage), so the amount of electric power consumed increases.

On the other hand, this PM aggregating force changes in accordance with the engine operating state in addition to the values of the voltages applied to the discharge electrodes, more particularly changes in accordance with the state of the exhaust flowing into the PM filter 34 which changes in accordance with the engine operating state (below, referred to as the “state of filter inflow and exhaust”).

FIG. 5 is a view showing the relationship between the PM aggregating force and state of filter inflow and exhaust (PM particle size, exhaust temperature, exhaust flow rate).

As shown in FIG. 5, the PM aggregating force tends to become larger when the PM particle size is small compared to when it is large. Further, the PM aggregating force tends to become larger when the temperature TE of the exhaust flowing into the PM filter is high compared to when it is low. Furthermore, the PM aggregating force tends to become larger when the amount of flow FE of the exhaust flowing into the PM filter is small compared to when it is large.

Therefore, even if making the amounts of charging Q1, Q2 of PM smaller when the PM aggregating force, which is determined from such a state of filter inflow and exhaust, is large compared to when it is small, it is possible to maintain the PM aggregating force and make the PM particle size larger, so it is possible to make the PM cake layer form earlier and make it easily for PM to build up in the pores of the inside of the partition walls 343 to thereby raise the PM trapping rate of the PM filter 34 earlier.

Further, as explained above, the PM trapping rate of the PM filter 34 becomes higher if the PM cake layer is formed, but in addition to this, in the same way as the PM aggregating force, it changes in accordance with the engine operating state, more particularly changes in accordance with the state of filter inflow and exhaust which changes in accordance with the engine operating state.

FIG. 6 is a view showing the relationship of the PM trapping rate and the state of filter inflow and exhaust.

As shown in FIG. 6, the PM trapping rate tends to become higher when the PM particle size in the exhaust flowing into the PM filter 34 is large compared to when it is small. Further, the PM trapping rate tends to become higher when the temperature TE of the exhaust flowing into the PM filter 34 is low compared to when it is high. Further, the PM trapping rate tends to become higher when the flow rate FE of the exhaust flowing into the PM filter 34 is small compared to when it is large.

Therefore, when the PM trapping rate determined by the state of filter inflow and exhaust is high, the amounts of charging Q1, Q2 of the PM are made smaller compared to when it is low. Due to this, even if the PM becomes smaller in particle size, the PM trapping rate can be maintained.

Therefore, in the present embodiment, the magnitudes of the voltages applied to the discharge electrodes were changed based on the PM aggregating force and PM trapping rate. Specifically, the target voltages to be applied to the discharge electrodes were set so that the voltages (absolute values) applied between the discharge electrodes become smaller when the PM aggregating force is large compared to when it is small and so that the voltages (absolute values) applied between the discharge electrodes become lower when the PM trapping rate is high compared to when it is low.

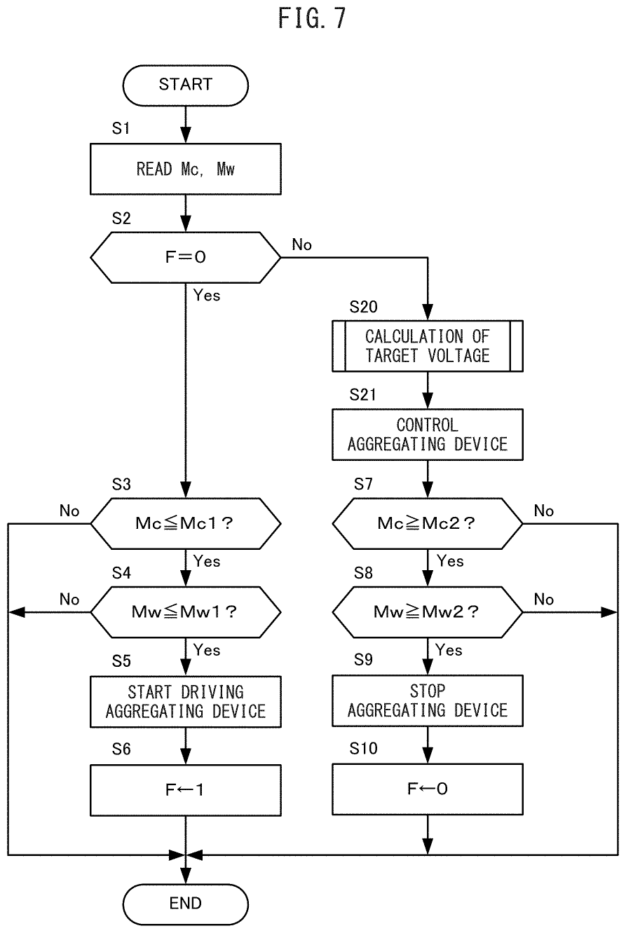

FIG. 7 is a flow chart explaining PM charging control according to the present embodiment. The electronic control unit 200 repeatedly performs the present routine during engine operation at predetermined processing cycles. In FIG. 7, the processing of step S1 to step S10 is similar to the first embodiment, so here explanation will be omitted.

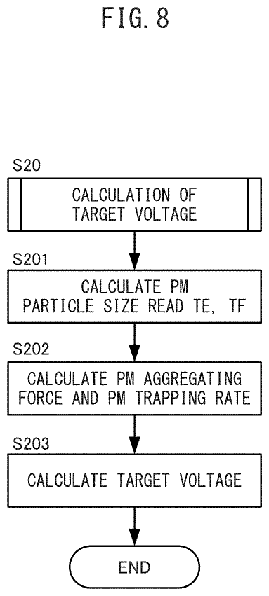

At step S20, the electronic control unit 200 performs target voltage calculation processing for calculating the target voltages to be applied between the discharge electrodes arranged at the first discharging part 352a and between the discharge electrodes arranged at the second discharging part 352b. Details of the processing for calculating the target voltages will be explained later referring to FIG. 8.

At step S21, the electronic control unit 200 controls the aggregating device 35 so that the voltages applied between the discharge electrodes arranged at the first discharging part 352a and between the discharge electrodes arranged at the second discharging part 352b become the target voltages.

FIG. 8 is a flow chart explaining details of the target voltage calculation processing.

At step S201, the electronic control unit 200 calculates the particle size of the PM contained in the exhaust discharged from the engine body 1. In the present embodiment, the electronic control unit 200 calculates the PM particle size based on the engine operating state (engine load and engine rotational speed) referring to a map prepared in advance by experiments etc. Further, the electronic control unit 200 reads in the exhaust temperature TE detected by the exhaust temperature sensor 213 and the exhaust flow rate FE estimated based on the intake amount and amount of fuel injected from the fuel injectors 13.

At step S202, the electronic control unit 200 calculates the PM aggregating force and the PM trapping rate based on the state of filter inflow and exhaust (PM particle size, exhaust temperature TE, exhaust flow rate FE) referring to a map prepared in advance by experiments etc.

At step S203, the electronic control unit 200 calculates the target voltages to be applied between the discharge electrodes arranged at the first discharging part 352a and between the discharge electrodes arranged at the second discharging part 352b based on the PM aggregating force and the PM trapping rate referring to a map prepared in advance by experiments etc. The absolute values of the target voltages to be applied between the discharge electrodes are set to become lower when the PM aggregating force is large compared with when it is small. Further, it is set so that it becomes lower when the PM trapping rate is high compared to when it is low.

The PM charging control part according to the present embodiment explained above is further configured so as to control the aggregating device 35 so that the amount of charging of the PM becomes smaller at the time of the engine operating state where the aggregating force of the PM when charging the PM becomes higher compared with the time of the engine operating state in which the aggregating force of the PM becomes lower.

Due to this, it is possible to keep down the amount of electric power for charging the PM while maintaining the PM aggregating force. For this reason, it is possible to keep down the amount of electric power for charging the PM more while raising the PM trapping rate of the PM filter 34 earlier.

Further, the PM charging control part according to the present embodiment is further configured so as to control the aggregating device 35 so that the amount of charging of the PM becomes smaller at the time of the engine operating state where the PM trapping rate of the PM filter 34 becomes higher compared with the time of the engine operating state where the PM trapping rate of the PM filter 34 becomes lower.

Due to this, it is possible to keep down the amount of electric power for charging the PM while maintaining the PM trapping rate. For this reason, it is possible to keep down the amount of electric power for charging the PM more while keeping the PM trapping rate of the PM filter 34 from falling.

Above, embodiments of the present disclosure were explained, but the embodiments only show some of the examples of application of the present disclosure and are not mean to limit the technical scope of the present disclosure to the specific configurations of the embodiments.

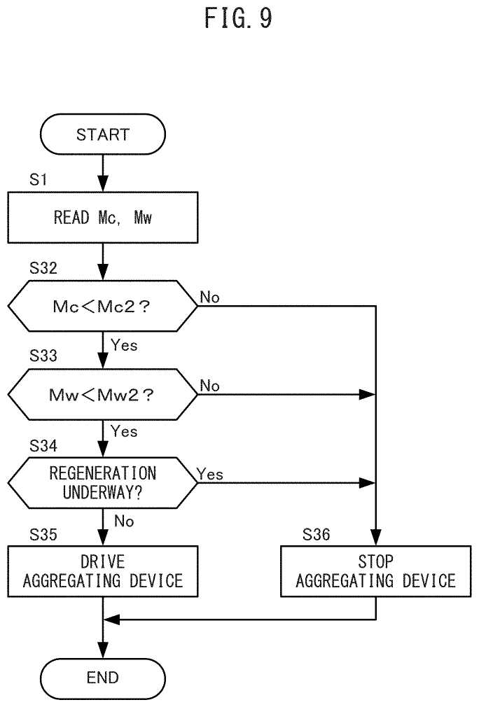

For example, the PM charging control of the first embodiment explained above may also be configured like the modification shown in the following FIG. 9.

FIG. 9 is a flow chart explaining PM charging control according to a modification of the above-mentioned first embodiment. The electronic control unit 200 repeatedly performs the present routine during engine operation at predetermined processing cycles. In FIG. 9, the processing of step S1 is similar to the first embodiment, so here an explanation will be omitted.

At step S32 and step S33, the electronic control unit 200 judges if the state of the PM filter 34 is in a low trapping state (that is, if the amount of PM buildup is less than the amount of buildup for stop judgment). If the low trapping state, it proceeds to the processing of step S34. On the other hand, the electronic control unit 200 proceeds to the processing of step S36 if the state of the PM filter 34 is a high trapping state.

In this modification, at step S32, the electronic control unit 200 judges if the amount of buildup of the cake layer Mc is less than the threshold value Mc2. The electronic control unit 200 judges that a PM cake layer of an extent able to trap PM with a small particle size has not been sufficiently formed and proceeds to the processing of step S33 if the amount of buildup of the cake layer Mc is less than the threshold value Mc2. On the other hand, the electronic control unit 200 judges that a PM cake layer of an extent able to trap PM with a small particle size has been formed and proceeds to the processing of step S36 if the amount of buildup of the cake layer Mc is the threshold value Mc2 or more.

Further, at step S33, the electronic control unit 200 judges if the amount of buildup of the wall layer Mw is less than the threshold value Mw2. The electronic control unit 200 judges that the PM has not built up in the pores inside the partition walls 343 to an extent able to trap PM with a small particle size and proceeds to the processing of step S34 if the amount of buildup of the wall layer Mw is less than the threshold value Mw2. On the other hand, the electronic control unit 200 judges that the PM has built up in the pores inside the partition walls 343 to an extent able to trap PM with a small particle size and proceeds to the processing of step S36 if the amount of buildup of the wall layer Mw is the threshold value Mw2 or more.

At step S34, the electronic control unit 200 judges if treatment for regeneration of the PM filter 34 is underway. The electronic control unit 200 proceeds to the processing of step S35 if treatment for regeneration of the PM filter 34 is not underway. On the other hand, the electronic control unit 200 proceeds to the processing of step S36 if treatment for regeneration of the PM filter 34 is underway since the PM in the exhaust flowing into the PM filter 34 basically can be burned away inside the PM filter 34 and in the end there is no need for enlarging the PM particle size.

At step S35, the electronic control unit 200 starts driving the aggregating device 35 if the aggregating device 35 had been stopped and makes the aggregating device 35 continue in the driven state as is if it had been driven.

At step S36, the electronic control unit 200 makes the aggregating device 35 stop if the aggregating device 35 had been driven and leaves the aggregating device 35 in the stopped state as is if it had been made to stop.

In this way, the PM charging control part according to this modification is configured to drive the aggregating device 35 to charge the PM so that the amount of charging of the PM becomes a predetermined amount of charging when the amount of PM buildup of the PM filter 34 is less than the amount of buildup for stop judgment (predetermined amount of buildup) and to stop the aggregating device 35 to stop the charging of the PM when the amount of PM buildup of the PM filter 34 is the amount of buildup for stop judgment or more. Further, the PM charging control part is further configured so as to stop the aggregating device 35 to stop the charging of the PM during regeneration of the PM filter 34.

Therefore, according to the PM charging control according to this modification, the PM is charged in a predetermined time period around the treatment for regenerating the PM filter 34 (time period when state of PM filter 34 is low trapping state, in other words, time period when the amount of PM buildup is less than the amount of buildup for stop judgment). Even if doing this, in the same way as the first embodiment, when the amount of PM buildup where the PM filter 34 is in a low trapping state around treatment for regeneration is a certain level or less, the particle size of the PM can be enlarged to form a PM cake layer earlier. Further, even if the PM enters inside of the partition walls 343, along with the enlargement of the PM, it becomes harder for the PM to pass through the pores, so it becomes possible to make PM build up in the pores. As a result, it is possible to raise the PM trapping rate of the PM filter 34 earlier to improve the exhaust emission.

1. A control device for an internal combustion engine,
the internal combustion engine comprising:
an engine body;
a filter provided in an exhaust passage of the engine body and trapping PM in exhaust; and
an aggregating device configured to charge PM in exhaust flowing into the filter to make it aggregate, wherein
the control device comprises a PM charging control part configured to control an amount of charging of the PM in exhaust flowing into the filter, and
the PM charging control part is configured to control the aggregating device so that the amount of charging of the PM becomes smaller when the amount of PM buildup of the filter is large compared to when it is small.

2. The control device for the internal combustion engine according to claim 1, wherein
the PM charging control part is configured to:
start driving the aggregating device to charge the PM so that the amount of charging of the PM becomes a predetermined amount of charging if the amount of PM buildup of the filter is less than or equal to a predetermined first amount of buildup; and
stop the aggregating device to stop charging the PM when the amount of PM buildup of the filter becomes a predetermined second amount of buildup larger than the first amount of buildup while driving the aggregating device.

3. The control device for the internal combustion engine according to claim 2, wherein
the control device further comprises a regeneration control part burning off the PM built up on the filter to regenerate the filter,
the first amount of buildup being a value corresponding to the amount of PM buildup at the time of completion of regeneration of the filter or right before or right after completion.

4. The control device for the internal combustion engine according to claim 2, wherein
the second amount of buildup is the amount of PM buildup enabling judgment of formation of a layer of PM on the surface of the filter.

5. The control device for the internal combustion engine according to claim 2, wherein
the second amount of buildup is the amount of PM buildup enabling judgment of the possibility of trapping PM inside the pores when PM enters the pores inside the partition walls forming the filter.

6. The control device for the internal combustion engine according to claim 2, wherein
the second amount of buildup is the amount of PM buildup enabling judgment of formation of a layer of PM on the surface of the filter and enabling judgment of the possibility of trapping PM inside the pores when PM enters the pores inside the partition walls forming the filter.

7. The control device for the internal combustion engine according to claim 1, wherein
the PM charging control part is further configured to control the aggregating device so that the amount of charging of the PM becomes smaller at the time of an engine operating state where the aggregating force of the PM in the case of charging the PM becomes high compared with the time of an engine operating state in which the aggregating force of the PM becomes low.

8. The control device for the internal combustion engine according to claim 1, wherein
the PM charging control part is further configured to control the aggregating device so that the amount of charging of the PM becomes smaller at the time of an engine operating state where the PM trapping rate of the filter becomes high compared with the time of an engine operating state in which the PM trapping rate of the filter becomes low.

9. The control device for the internal combustion engine according to claim 1, wherein
the PM charging control part is configured so as to drive the aggregating device to charge the PM so that the amount of charging of the PM becomes a predetermined amount of charging when the amount of PM buildup of the filter becomes less than a predetermined amount of buildup and so as to stop the aggregating device to stop the charging of the PM when the amount of PM buildup of the filter is the predetermined amount of buildup or more.

10. The control device for the internal combustion engine according to claim 9, wherein
the control device further comprises a regeneration control part burning off the PM built up on the filter to regenerate the filter, and
the PM charging control part is further configured to stop the aggregating device to stop the charging of the PM during regeneration of the filter.
